(19) United States
(12) Patent Application Publication
(10) Pub. No.: US 2005/0265266 A1
(43) Pub. Date: Dec. 1, 2005

(54) OPTICAL DISC DRIVE THAT DOWNLOADS OPERATIONAL FIRMWARE FROM AN EXTERNAL HOST

(76) Inventors: Chih-Chiang Wen, Hsin-Chu Hsien (TW); Yi-Chuan Chen, Taipei City (TW); Jeng-Horng Tsai, Kao-Hsiung City (TW); Ping-Sheng Chen, Chia-Yi Hsien (TW)

Correspondence Address: NORTH AMERICA INTELLECTUAL PROPERTY CORPORATION, P.O. BOX 506, MERRIFIELD, VA, 22116, US

(21) Appl. No.: 10/709,735

(22) Filed: May 25, 2004

(51) Int. Cl. H04B 3/20

(52) U.S. Cl. 370/286

(57) ABSTRACT

An optical disc drive includes a microprocessor, a control IC, an RF IC, and an interface unit. The microprocessor is electrically coupled to the control IC. The control IC is electrically coupled to the RF IC, a volatile RAM, an optional non-volatile ROM, and to a bus interface for communications with an external host. The interface unit is electrically coupled to the bus interface. Initialization of the optical disc drive is performed using initialization data stored in a non-volatile manner in the ROM, if present, or downloaded from the host if the ROM is not present. After the initialization, the interface unit signals an application program in the host to download the optical drive's operational firmware and writes received data into the RAM. The microprocessor is initialized with the operational firmware's starting address and the microprocessor executes the downloaded operational firmware.

### BACKGROUND OF INVENTION

1. Field of the Invention

This invention relates generally to an optical disc drive and more specifically to an optical disc drive that downloads operational firmware from an external host.

2. Description of the Prior Art

Optical discs have become a preferred data storage medium due to their ease of use, low cost, portability, and capacity. Many types of optical discs enjoy wide usage in today's technologically savvy society. Rapid advancements in the art have led from read-only CDs to rewriteable CDs to read-only DVDs to various forms of rewriteable DVDs at a low cost enabling widespread application. Obviously, the use of optical discs requires an appropriate optical disc drive, which in turn requires operational firmware that is executed by a microprocessor and circuitry within the optical disc drive to control operations of the drive. Conventionally, this operational firmware is stored in a non-volatile memory electrically coupled to the microprocessor and is immediately available for execution when the optical disc drive is initialized or becomes active.

Please refer to FIG. 1, which is a functional block diagram of a conventional optical disc drive 10 comprising a microprocessor 35, a control IC (integrated circuit) 30, an RF IC 40, a non-volatile ROM (read only memory) 25, and a volatile RAM (random access memory) 20. Normal operations of the optical disc drive 10 include an optical disc 45 loaded onto a rotor of a motor (not shown) and controlled to rotate at a predetermined velocity. During a read operation, electrical signals representing data optically read from the optical disc 45 are processed by RF IC 10, transmitted to the control IC 30 for further decoding and processing, and finally sent to an external host 15 via a bus interface 55. The bus may be of any type, but an IDE bus is given as one common example. During a write operation (if available), electrical signals representing data are sent from the host 15 to the control IC 30 for processing, then transmitted to the RF IC 40 for further processing, and are finally burned onto the rotating surface of the optical disc 45. While in the process of either a read or write operation, the volatile RAM 20 may be used as a buffer for temporary data storage or to allow error checking to be performed.

All operations of the optical disc drive 10, including those of the control IC 30 and the RF IC 40, are controlled by the microprocessor 35. As with all processors, the microprocessor 35 requires computer code to manage the optical disc drive 10 resources under its control. This computer code is known as firmware and includes all needed data, commands, programs, instructions, and other information used in the normal operation of the optical disc drive 10. The firmware 50 for the optical disc drive 10 is stored in the non-volatile ROM 25 that is electrically coupled to the microprocessor 35. The use of a non-volatile ROM 25 for the storage of firmware is necessary so that the firmware 50 will remain available for execution by the microprocessor 35 each time that the optical disc drive 10 is powered off and on again.

Although not required for normal operations of the optical disc drive 10, at some point in time, a manufacturer may choose to provide updated firmware for an existing optical disc drive 10. The updating procedure requires the microprocessor 35 to execute an update program to write the new firmware into the ROM 25. U.S. Pat. Nos. 6,170,043 B1 and 6,607,881 B1, by the same assignee and incorporated herein by reference, describe in detail some such methods for updating firmware. However, the update program needs to be stored in the ROM 25 along with rest of the updated firmware, further increasing the size of the ROM 25.

The size of the firmware, and thus the minimum size of the ROM 25, is dependent to a great degree on the complexity and number of operations that need to be performed by the optical disc drive 10. As consumer demand has forced manufacturers to add more and more functionalities to the optical disc drive 10, the size of the needed firmware has grown rapidly, requiring a correspondingly larger ROM 25. Because the ROM 25 is usually a form of FLASH memory or EEPROM (electrically erasable programmable read only memory) and FLASH memory and EEPROM are both much more expensive per megabyte than volatile memory, the ROM 25 has become an increasingly substantial part of the total cost of the optical disc drive 10.

### SUMMARY OF INVENTION

It is therefore a primary objective of the claimed invention to reduce the cost of an optical disc drive by reducing the size of, or completely eliminating, non-volatile memory utilized for the storage of operational firmware.

A first claimed optical disc drive circuit includes a microprocessor, a control IC, an RF IC, and an interface unit. The microprocessor is electrically coupled to the control IC. The control IC is electrically coupled to the RF IC, a non-volatile ROM, a volatile RAM, and to a bus interface for communications with an external host. The interface unit is electrically coupled to the bus interface. The ROM is only required to store initialization data for the optical disc drive.

A second claimed optical disc drive circuit includes a microprocessor, a control IC, an RF IC, and an interface unit, but non-volatile ROM is not necessary. The microprocessor is electrically coupled to the control IC. The control IC is electrically coupled to the RF IC, a volatile RAM, and to a bus interface for communications with an external host. The interface unit is electrically coupled to the bus interface.

After a power-on, reset, or in response to a request or command by an application program in the host, the optical disc drive enters download firmware mode. Initialization of the optical disc drive is performed using initialization data stored in a non-volatile manner in the ROM of the first claimed optical disc drive or downloaded from the host in the second claimed optical disc drive. After the initialization, the interface unit signals the application program in the host to download the optical drive's operational firmware. The interface unit receives the operational firmware and transfers it to the control IC. The control IC then writes it into the RAM. When the download is complete, the microprocessor is initialized with the starting address of the operational firmware in RAM and the download mode exited. A normal mode is then entered where the microprocessor executes the downloaded operational firmware to perform the normal operations of the optical disc drive.

By utilizing an interface unit to download and place into RAM the optical disc drive's firmware stored in a non-volatile manner in the host, the present invention can reduce the size of, or completely eliminate the need of expensive non-volatile storage of firmware in the optical disc drive, substantially reducing manufacturing costs.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a conventional optical disc drive.

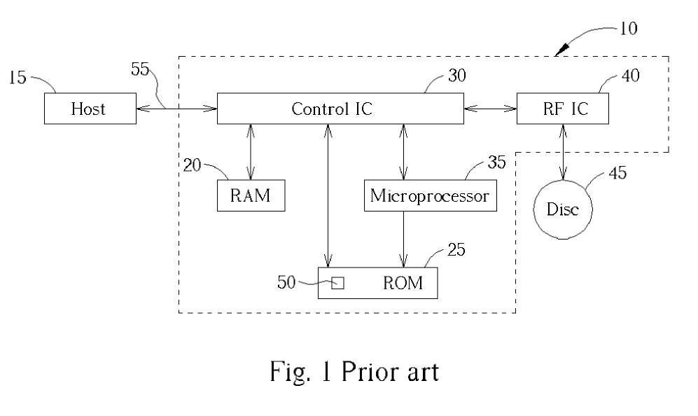

FIG. 2 is a functional block diagram of an optical disc drive according to the present invention.

FIG. 3 is a functional block diagram of another optical disc drive according to the present invention.

FIG. 4 is a flow chart of the use of the present invention.

FIG. 5 is a functional block diagram of another optical disc drive according to the present invention.

FIG. 6 is a functional block diagram of another optical disc drive according to the present invention.

### DETAILED DESCRIPTION

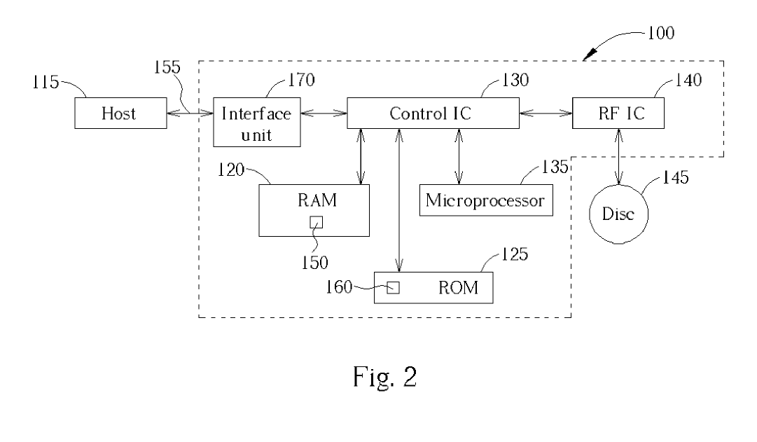

Please refer to FIG. 2, which is a functional block diagram of an optical disc drive 100 according to the present invention. The optical disc drive 100 comprises a microprocessor 135, a control IC (integrated circuit) 130, an RF IC 140, a non-volatile ROM (read only memory) 125, a volatile RAM (random access memory) 120, and an interface unit 170. The microprocessor 135 is connected to the control IC 130. The control IC 130 is electrically coupled to the RF IC 140, the microprocessor 135, the RAM 120, the ROM 125, and to the interface unit 170 which is electrically coupled to a bus interface 155 for communications with an external host 115. Here, the host can be a computer system or a memory system. The control IC 130 includes a RAM controller (not shown) to interface with the RAM 120 and a ROM controller (not shown) to interface with the ROM 125. The RF IC 140 is electrically coupled to the control IC 130 and to other (not shown) circuitry for interfacing with an optical disc 145.

Although it is preferred that the ROM 125 be a type of FLASH memory or EEPROM, the ROM 125 may be of any type of non-volatile memory and the present invention is not limited by this disclosure. For example, the ROM 125 may be a form of OTPROM (one time programmable ROM) although the use of OTPROM would make code updates difficult or impossible. Additionally, the volatile RAM 120 is preferred to be a DRAM (dynamic random access memory) but may be of another form such as SRAM (static RAM). The bus interface 155 may be of any type including but not limited to USB, IDE, SATA, SAS, or SCSI.

Throughout this paper, the term “normal operations” of an optical disc drive is defined to include at least a read operation in which electrical signals representing data optically read from an optical disc are processed by an RF IC, transmitted to the control IC for further decoding and processing, and finally sent to an external host via a bus interface.

Some optical disc drives are also capable of writing data to an optical disc in various popular protocols such as CD-R(W) and DVD+-R(W) as two non-limiting examples. When the optical disc drive has this capability, normal operations may also include a write operation where electrical signals representing data are sent from a host to a control IC for encoding and processing, then transmitted to an RF IC for further processing, and are finally burned onto the rotating surface of an optical disc.

All normal operations of the optical disc drive 100 are controlled by the microprocessor 135. As previously stated, the microprocessor 135 requires computer code to manage the optical disc drive 100 resources under its control. This computer code is known as firmware and is used in the normal operations of the optical disc drive 100. It is important to note that the firmware can be broken down into two major categories. The first category of firmware, which in this paper will be termed “operational firmware”, comprises all of the data, commands, programs, instructions, and other information used to perform the normal operations of the optical disc drive. Examples of normal operations may include a read operation, a write operation, controlling rotational speed of the optical disc, and/or determining the type of optical disc currently in use.

The second category, which in this paper will be termed “initialization data”, comprises all of the data, parameters, and/or instructions required to initialize the components of the optical disc drive before the microprocessor can execute the operational firmware and normal operations can begin. The exact initialization data normally is device specific and manufacturer dependent.

Although the comparison is certainly not precise for many reasons, the utilization of the initialization data to prepare the optical disc drive 100 for the operational firmware is somewhat akin to the utilization of BIOS to prepare a computer system for an operating system. The initialization data cannot be used to perform normal operations of the optical disc drive 100, but instead merely initializes and prepares the optical disc drive 100 so that normal operations can be performed when the operational firmware is executed by the microprocessor 135.

Computer code for updating firmware in the prior art optical disc drive 10 would be considered neither initialization data nor operational firmware because it merely modifies current operational firmware and cannot be used to initialize the optical disc drive 100 or for normal operations of the optical disc drive 100 as described above. Furthermore, as will become apparent, the present invention does not require specialized software for updating operational firmware because the operational firmware 150 is always as current as was available at power-on.

Unlike the prior art disc drive 10 that stores both the initialization data 50 and the operational firmware 50 in the non-volatile ROM 25, the present invention optical disc drive's 100 non-volatile ROM 125 is only required to store maybe up to a few kilobytes of initialization data 160. Because the initialization data 160 is only a small fraction of the size of the operational firmware and the operational firmware is not stored in the ROM 125, the ROM 125 can be much smaller than the ROM 25 of the prior art, reducing manufacturing costs.

Because the microprocessor 135 still requires operational firmware to control normal operations of the optical disc drive 100 and because the optical disc drive 100 already comprises a volatile RAM 120, the present invention stores the needed operational firmware 150 in a predefined location of the already existing RAM 120. Although other portions of the RAM 120 may still be utilized as a buffer for temporary data storage or to allow error checking to be performed, a predefined section of the RAM 120 can be reserved for the operational firmware 150. The microprocessor 135 has access to the reserved section of the RAM 120 for execution of the operational firmware 150 either through a direct connection or via the control IC 130 according to design considerations.

Normally the RAM 120 is large enough to accommodate the operational firmware 150 without degrading performance of the optical disc drive 100. However, even if the RAM 120 should need to be expanded by the size of the added operational firmware 150, the cost of any needed additional RAM 120 is much less than the savings incurred by the corresponding reduction in size of the ROM 125.

To make the operational firmware 150 available to the microprocessor 135 after a power-on or possibly a reset, the optical disc drive 100 introduces an interface unit 170. The interface unit 170 may be a separate unit or may just as easily be incorporated into the control IC 130, but is shown as a separate unit in FIG. 2 for emphasis. The interface unit is electrically coupled to the bus interface 155 and has the functionality of receiving the operational firmware 150 from the host 115 and transferring it to the control IC 130. The control IC 130 loads the received operational firmware 150 into the RAM 120. The interface unit 170 does not execute the received operational firmware 150, but merely transfers the received code to the reserved section of the RAM 120 as data where the microprocessor 135 can execute it after the transfer is complete. The interface unit 170 may be hardware or a software macro to perform handshaking with the host 115 and to perform the transfer. Obviously, this transfer of operational firmware 150 from the host 115 to the RAM 120 requires the non-volatile storage of a copy of the operational firmware 150 within the host 115, perhaps on a local hard drive, which is tremendously cheaper per megabyte than is either the FLASH memory or EEPROM used by the prior art optical disc drive 10 to store the operational firmware in a non-volatile manner.

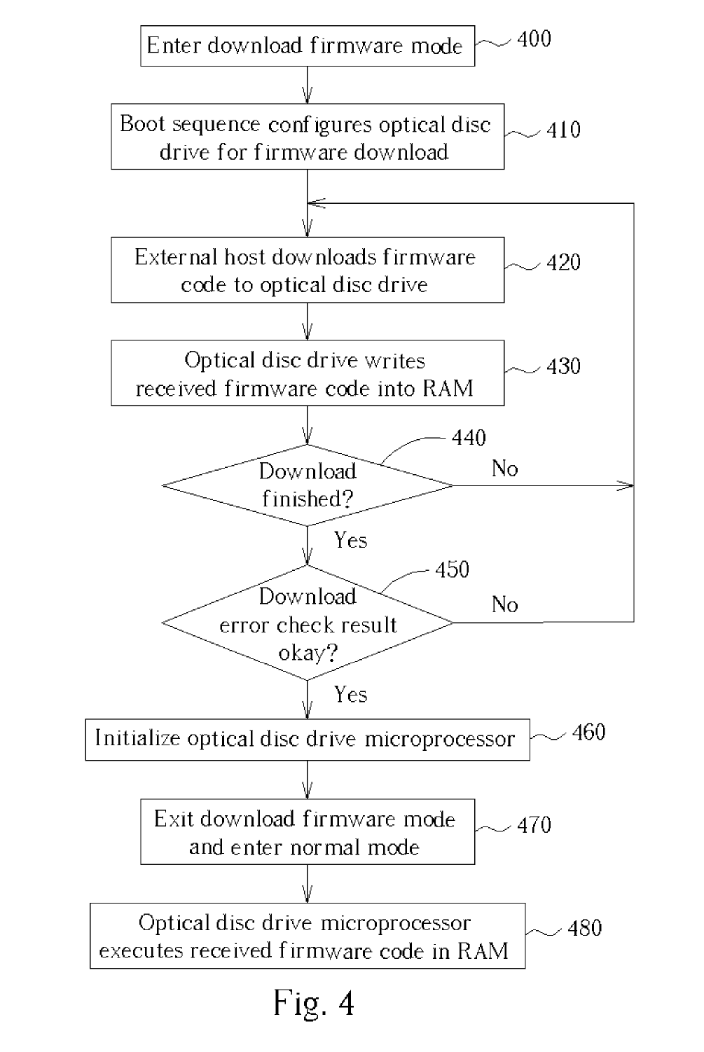

Now, please refer to FIG. 4, which is a flowchart of how the present invention is applied to the optical disc drive 100. After a power-on, reset, or in response to a request or command by an AP (application program) in the host 115, as part of the startup procedures, the optical disc drive 100 enters what will be termed a “download firmware mode” (Step 400). It is preferred although not necessary that the optical disc drive defaults to the download firmware mode whenever the RAM 120 does not comprise the needed operational firmware 150.

Shown in step 410, after entering the download firmware mode, the initialization data 160 stored in the ROM 125 is used to initialize the optical disc drive 100. Because the initialization data 160 may comprise parameters pertinent to properly controlling the RAM 120, the initialization of the optical disc drive 100 should be completed before moving on to step 420. An AP in the host may request the initialization procedure to begin. After completion of the initialization process, control is passed to the interface unit 170, which may signal the AP in the host 115 to begin downloading the operational firmware 150. In steps 420 through 440, operational firmware 150 is received by the interface unit 170, transferred to the control IC 130, and written into the reserved section of the RAM 120. Step 450, that of performing an error check, such as a check sum, on the downloaded operational firmware 150 is optional but recommended. If an error is detected, the optical disc drive 100 can resend the signal to the host 115 to begin again downloading the operational firmware 150 and steps 420 through 440 are repeated.

After the downloading of the operational firmware 150 is complete, the microprocessor 135 is initialized with the starting address in the RAM 120 of the operational firmware (step 460), the download mode is exited and a “normal mode” is entered (step 470) where control is passed to the initialized microprocessor 135. Step 480 indicates the normal mode of the optical disc drive 100 where the microprocessor 135 executes the downloaded operational firmware 150 to perform the normal operations of the optical disc drive 100.

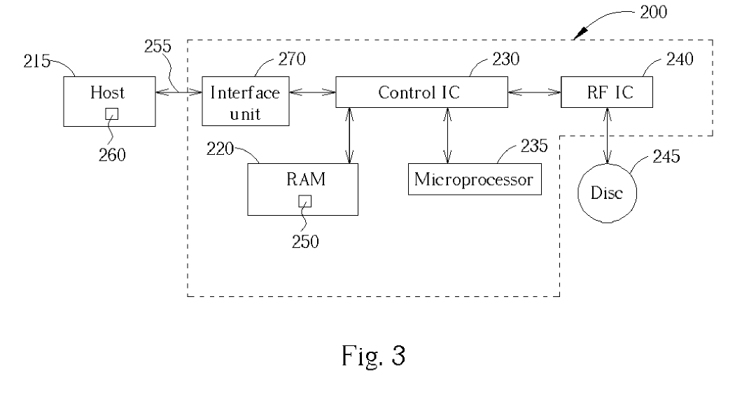

Please refer now to FIG. 3, which is a functional block diagram of a second optical disc drive 200 according to the present invention. Quite similar to the optical disc drive 100 of the previous embodiment, the optical disc drive 200 comprises a microprocessor 235, a control IC 230, an RF IC 240, an interface unit 270, and a volatile RAM 220. The microprocessor 235 is connected to the control IC 230. The control IC 230 is electrically coupled to the RF IC 240, the microprocessor 235, the RAM 220, and the interface unit 270, which is electrically coupled to a bus interface 255 for communications with an external host 215. The control IC 230 includes a RAM controller (not shown) to interface with the RAM 220. The RF IC 240 is electrically coupled to the control IC 230 and to other (not shown) circuitry for interfacing with an optical disc 245. The volatile RAM 220 is preferred to be a DRAM but may be of another form such as SRAM. The bus interface 255 may be of any type including but not limited to USB, IDE, SATA, SAS, or SCSI.

Although functionally and structurally similar in almost every respect, the difference between the optical disc drive 200 and that of the previous embodiment is the absence of non-volatile ROM for storing the initialization data. In this embodiment, the initialization data is stored in a non-volatile manner in the external host 215 along with a copy of the operational firmware. In FIG. 3, the operational firmware is noted as 260 in the host 215 and as 250 in the RAM 220. The initialization data may also be stored in the same memory of the host 215.

For the optical disc drive 200 to function properly, a small change is made to the description of step 410 in the operational flowchart of FIG. 4. Here, after entering the download firmware mode, the interface unit 270 signals the AP in the host to first download the initialization data. The received initialization data is then utilized to initialize the optical disc drive 200. All other steps shown in FIG. 4 can remain unchanged as previously described, with the operational firmware being downloaded from the host 215 and placed into the RAM 220 for execution by the microprocessor 235 after the normal mode has been entered. In this manner, the present invention eliminates the need for non-volatile storage of firmware within the optical disc drive 200, substantially reducing manufacturing costs.

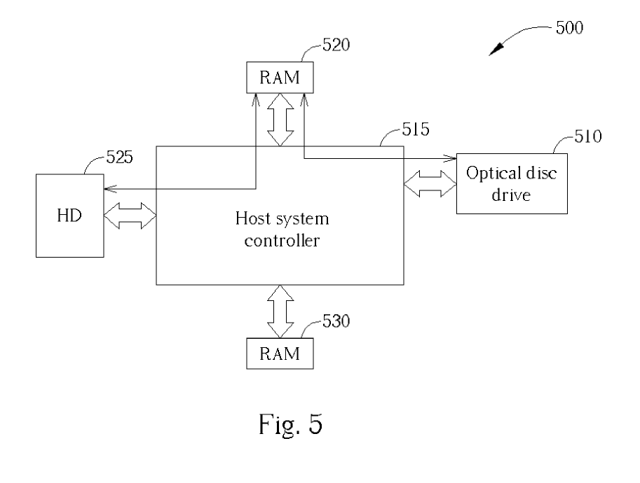

One feature of the invention is that the microprocessor executes the downloaded operational firmware while stored in a volatile memory. The volatile memory can be external to the optical disc drive. For one example of an embodiment of a present invention optical disc drive utilizing external RAM memory for execution of the operational firmware, please refer to FIG. 5. The computer system 500 comprises a host controller 515, a BIOS 530, a volatile RAM memory 520, a form of non-volatile memory which can be a hard drive 525 but may conceivably be of another form such as an optical disc, and an optical disc drive 510. In FIG. 5, the operational firmware is downloaded from the hard drive 525 into the RAM 520, where it remains while executed to control normal operations of the optical disc drive 510. The RAM 520 functions similarly to the RAM 120. During the normal operation, the RAM 520 can be accessed only by the optical disc drive, or shared by both the optical disc drive and the host. Initialization data may be stored either in the non-volatile memory 525 or within the optical disc drive 510 as previously described.

The use of a volatile memory external 520 to the optical disc drive 510 to hold executing operational firmware may provide an additional benefit in that the interface unit of the present invention can be simplified or possibly eliminated. Obviously, a different form of an interface unit that allows the optical disc drive's microprocessor (not shown) to execute operational firmware stored external to the optical disc drive 510 remains necessary. Additionally, although not limiting to the present invention, it is highly preferred that the bus interface connecting the optical disc drive 510 with the host controller 515 have a bandwidth high enough to not delay data transfers or degrade performance of the optical disc drive 510 due to the externally executed firmware.

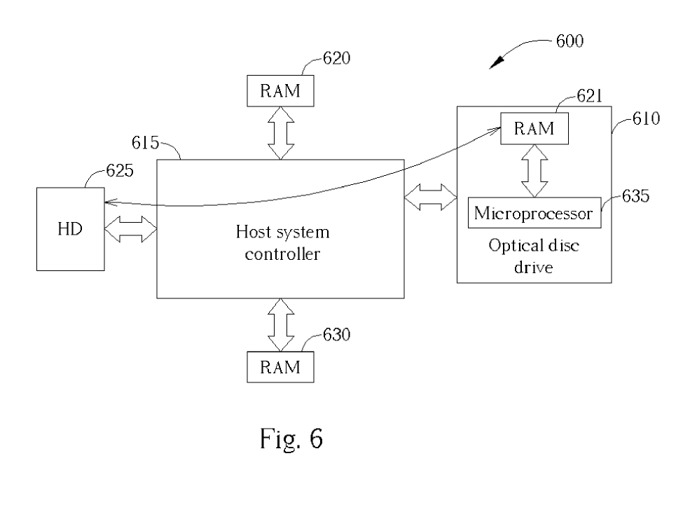

Another way of downloading the operational firmware is through a host system controller in the host instead of downloading through the control of the microprocessor, as shown in FIG. 6. In this example, the computer system 600 comprises a host controller 615, a BIOS 630, a non-volatile memory 625, and a volatile RAM memory 620. Also connected to the host controller 630 is an optical disc drive 610 that in turn comprises a microprocessor 635 and a volatile RAM memory 621. In FIG. 6, the operational firmware is downloaded from the non-volatile memory 625 to the RAM 621 of the optical disc drive 610 under the control of the host controller 615. Once the firmware has been downloaded into the RAM 621, the firmware is executed by the microprocessor 635 as previously described. Again, initialization data may be stored in either the non-volatile memory 625 or within the optical disc drive 610.

The prior art optical disc drive stores all initialization data and operational firmware in a non-volatile memory within the optical disc drive. A microprocessor within the prior art optical disc drive executes the operational firmware while the operational firmware is stored within the non-volatile memory to control normal operations of the optical disc drive. As consumer demand has prompted increased functionalities in today's optical disc drives, the non-volatile memory is becoming an increasingly substantial portion of the cost of manufacturing the optical disc drive.

In contrast, the present invention downloads operational firmware stored in a host computer and stores and executes the downloaded operational firmware in volatile memory, substantially reducing the required size of non-volatile memory in an optical disk drive and saving manufacturing costs. The non-volatile memory in the optical disc drive may be completely eliminated if initialization data required to initialize the optical disc drive is additionally stored in the host computer, further reducing costs. Another benefit of downloading the operational firmware is that specialized update programs are no longer necessary, further reducing costs. A simple and inexpensive interface unit, which may be hardwired or a macro, is utilized to download from the host and place into existing RAM the optical disc drive's operational firmware. The optical disc drive's microprocessor executes the operational firmware while it is stored in the volatile memory to control normal operations of the optical disc drive. As such, the present invention can reduce the size of, or eliminate the need of expensive non-volatile storage of firmware in the optical disc drive, substantially reducing manufacturing costs.

Those skilled in the art will readily observe that numerous modifications and alterations of the device and method may be made while retaining the teachings of the invention. The major key to the present invention lies not in exactly where the RAM comprising the operational firmware is located (external or internal to the optical disc drive) nor in exactly how the operational firmware is downloaded into the RAM. The intended scope of the present invention is to include the microprocessor of the optical disc drive executing the operational firmware while the operational firmware is in the RAM to control normal operations of the optical disc drive, eliminating the need of costly non-volatile memory within the optical disc drive. Accordingly, the above disclosure should be construed as limited only by the metes and bounds of the appended claims.

1. An optical disc drive circuit comprising:
a bus interface for communications with a host;
an interface unit electrically coupled to the bus interface for downloading operational firmware from the host;
a control circuit electrically coupled to the interface unit for transferring the downloaded operational firmware to a volatile memory; and
a microprocessor electrically coupled to the control circuit for executing the downloaded operational firmware while stored in the volatile memory;
wherein the microprocessor controls the normal operations of the optical disc drive according to the downloaded operational firmware.

2. The optical disc drive circuit of claim 1 wherein the bus interface conforms to USB, IDE, SATA, SAS, or SCSI interface standards.

3. The optical disc drive circuit of claim 1 wherein the interface unit is a macro.

4. The optical disc drive circuit of claim 3 wherein the macro comprises handshaking, data reception, and writing received data into the memory functions.

5. The optical disc drive circuit of claim 1 wherein the interface unit further downloads initialization data for the optical disc drive.

6. The optical disc drive circuit of claim 1 wherein the control circuit is electrically coupled to a non-volatile memory which stores initialization data without storing operational firmware.

7. The optical disc drive circuit of claim 1 wherein the host is a computer system.

8. The optical disc drive circuit of claim 1 wherein the microprocessor executes the downloaded operational firmware without accessing a non-volatile memory.

9. The optical disc drive circuit of claim 1 wherein the normal operations of the optical disc drive at least include reading data from an optical disc.

10. The optical disc drive circuit of claim 1 wherein the volatile memory comprises the downloaded operational firmware being executed by the microprocessor to control normal operations of the optical disc drive.

11. An optical disc drive comprising a download mode wherein operational firmware is downloaded from an external host and stored into a volatile memory of the optical disc drive, followed by a normal mode wherein a microprocessor of the optical disc drive executes the stored operational firmware to control normal operations of the optical disc drive.

12. The optical disc drive of claim 11 wherein the normal operations of the optical disc drive at least include reading data from an optical disc, processing the data, and transferring the processed data to the host.

13. The optical disc drive of claim 11 wherein data required for the initialization of the optical disc drive is downloaded from the external host to initialize the optical disc drive before the operational firmware is downloaded.

14. The optical disc drive of claim 11 wherein the operational firmware is downloaded over a bus interface conforming to USB, IDE, SATA, SAS, or SCSI interface standards.

15. The optical disc drive of claim 11 wherein the host is a computer system.

16. A method of operating an optical disc drive, the optical disc drive comprising a control circuit connected to a microprocessor, a volatile memory, and a bus interface connected to a host, the method comprising:
downloading operational firmware from the host;
writing the operational firmware into the volatile memory; and
the microprocessor executing the operational firmware in the volatile memory to control normal operations of the optical disc drive.

17. The method of claim 16 further comprising downloading data required for the initialization of the optical disc drive from the external host before the operational firmware is downloaded.

18. The method of claim 16 wherein the operational firmware is downloaded over a bus interface conforming to USB, IDE, SATA, SAS, or SCSI interface standards.

19. The method of claim 16 further comprising the optical disc drive transmitting an electrical signal to an application program in the host to begin downloading the operational firmware.

20. The method of claim 16 wherein the host is a computer system.

21. A computer system comprising:
a host computer comprising operational firmware for controlling operations of an optical disc drive; and
an optical disc drive comprising:
a volatile memory comprising the operational firmware downloaded from the host computer over a connecting bus interface; and
a microprocessor executing the operational firmware in the volatile memory for controlling normal operations of the optical disc drive.

22. The computer system of claim 21 wherein the normal operations of the optical disc drive at least include controlling the rotational speed of an optical disc in the optical disc drive and reading data from the optical disc.

23. The computer system of claim 21 wherein the bus interface conforms to USB, IDE, SATA, SAS, or SCSI interface standards.

24. The computer system of claim 21 wherein data required for the initialization of the optical disc drive is downloaded from the external host before the operational firmware is downloaded.

25. An optical disc drive controller comprising:
a bus interface for communications with a host;
a volatile memory for storing operational firmware downloaded from the host;
a microprocessor for controlling normal operations of the optical disc drive by executing the operational firmware stored in the volatile memory;
an RF circuit; and
a control circuit connected to the bus interface, the volatile memory, the microprocessor, and the RF circuit.

26. The optical disc drive controller of claim 25 wherein the volatile memory comprises the downloaded operational firmware being executed by the microprocessor to control normal operations of the optical disc drive.

27. An optical disc drive circuit used in a host system, wherein the optical disc drive circuit has operational firmware downloaded from the host system to a volatile memory through a bus interface every time after the host being powered on, the optical disc drive circuit comprising:
a microprocessor for executing the downloaded operational firmware while stored in the volatile memory;
wherein the microprocessor controls the normal operations of the optical disc drive according to the downloaded operational firmware.

28. The optical disc drive circuit of claim 27 wherein the bus interface conforms to USB, IDE, SATA, SAS, or SCSI interface standards.

29. The optical disc drive circuit of claim 27 wherein the microprocessor accesses a non-volatile memory which stores initialization data without storing operational firmware.

30. The optical disc drive circuit of claim 27 wherein the host system is a computer system.

31. The optical disc drive circuit of claim 27 wherein the microprocessor executes the downloaded operational firmware without accessing a non-volatile memory.

32. The optical disc drive circuit of claim 27 wherein the host system comprises the volatile memory.

33. The optical disc drive circuit of claim 27 wherein the host system comprises a host controller accessing the volatile memory that is shared by the host system and the microprocessor during the normal operation.

34. The optical disc drive circuit of claim 27 wherein the volatile memory is accessed only by the optical disc drive circuit on the normal operation.

35. The optical disc drive circuit of claim 27 wherein the optical disc drive circuit comprises the volatile memory.
